(19) United States
(12) Patent Application Publication
(10) Pub. No.: US 2012/0212067 A1
(43) Pub. Date: Aug. 23, 2012

(54) PORTABLE COMPLEX POWER SUPPLY APPARATUS

(75) Inventor: WEN-CHING LAI, Taipei City (TW)

(73) Assignee: SUNWELL DYNAMICS RESOURCES CORP., Taipei City (TW)

(21) Appl. No.: 13/345,053

(22) Filed: Jan. 6, 2012

(30) Foreign Application Priority Data
Feb. 17, 2011 (TW) 100105279

(51) Int. Cl. H02J 1/00

(52) U.S. Cl. 307/84

(57) ABSTRACT

A portable complex power supply apparatus includes a portable case in which a hand generator, a power input connection member, a power control circuit element, a power storage unit, and an output connector are disposed or contained. Thus, the portable complex power supply apparatus is capable of supplying electric power everywhere by manpower or a power generator connected therewith, storing the electric power, and outputting the electric power to an electrical device with varies kinds of power specifications, so as to provide convenience in supplying electric power.

### FIELD OF THE INVENTION

The present invention relates to a portable device for storing and generating electric power, and more particularly to a portable complex power supply apparatus.

### BACKGROUND OF THE INVENTION

The power generating manners such as nuclear power generation, hydraulic power generation, thermal power generation, wind power generation, solar power generation, and the like have been known. And, the power generating devices using these power generating manners are all immovable facilities such as a solar power plant, a power generation tower, or the like. Electric power generated from these power generating devices is supplied to a demand area through a power line for a long distance and is then distributed to the households.

Because these power supply devices are immovable, users only can enjoy their electric power indoor. Once they need to use the electric power outdoor, it must have an additional power line extending to outside. Thus, it is difficult to obtain the electric power at a place far away from an indoor power source.

Furthermore, no matter in the outdoor activities such as mountain-hiking or paddling, in security job such as patrolling, or in emergency event such as rescuing, it is difficult to use immovable power supply devices and is hard to rely on a power storage means such as a battery.

Further, the electric power obtained from a battery, which is a DC power, can not be used in an electrical household device. On the contrary, the household power, which is an AC power, also can not be used in an electrical device which uses the DC power, such as a flashlight. Moreover, in addition to the difference of DC power and AC power, different electrical device usually have different rated voltage and current value. These problems can not be solved by the conventional immovable power supply devices.

### SUMMARY OF THE INVENTION

In view of the above, there exists a problem that the conventional power supply device in a prior art can not be used to supply electric power for an outdoor use, a long time mobile usage, and a temporary usage.

Therefore, it is an object of the present invention to provide a portable complex power supply apparatus for supplying electric power anywhere anytime, so as to improve the above drawback of the conventional power supply device.

The present invention overcomes the drawbacks of the prior art, and provides a portable complex power supply apparatus comprising: a portable case; a hand generator provided with a shaking member provided on an outer portion of the portable case and having a hand power output terminal; a wind power input connection member provided on the portable case for connecting with a wind power generator; a power control circuit element including an input regulating circuit, a monitoring/switching circuit, and an output control circuit, the input regulating circuit being electrically connected with the hand power output terminal of the hand generator and the wind power input connection member to regulate the received electric power into an input power having a DC power form, the monitoring/switching circuit conducting or isolating the input power from the input regulating circuit to the output control circuit depending on the voltage and/or the current value of the input power, and the output control circuit regulating the input power into an output power having a DC or AC power form and adjusting the output power to have a predetermined voltage and current value; a power storage unit electrically connected between the monitoring/switching circuit and the output control circuit for storing the input power or discharging the electric power stored therein; and an output connector, electrically connected with the output control circuit, used for connecting with an electrical device to transmit the output power to the electrical device via the output connector.

In an embodiment of the present invention, the portable complex power supply apparatus further comprises an external operating unit, provided on the portable case, being electrically connected with the power control circuit element.

In an embodiment of the present invention, the portable complex power supply apparatus further comprises a portable wind power generator including: a foldable stand; a wind fan means disposed on the foldable stand; a wind turbine means disposed on the foldable stand; a generator unit disposed on the foldable stand; and a wind power output member electrically connected with the generator unit.

In an embodiment of the present invention, the portable complex power supply apparatus further comprises a solar power input connection member, provided on the portable case, electrically connected with the input regulating circuit. And, the portable complex power supply apparatus further comprises a portable solar power generator including: a solar panel; a joint member provided with an end thereof connected to the solar panel and the other end thereof having one or more degrees of freedom related to said end; a fixing member connected to the other end of the joint member; and a solar power output member electrically connected with the solar panel.

In an embodiment of the present invention, the portable complex power supply apparatus further comprises a household power input connection member, provided on the portable case, being electrically connected with the input regulating circuit.

In an embodiment of the present invention, the power storage unit is further connected with a storage monitoring/switching circuit.

In an embodiment of the present invention, the output control circuit of the power control circuit element is further electrically connected with an inverter.

In an embodiment of the present invention, the output control circuit of the power control circuit element includes a voltage regulating circuit.

In an embodiment of the present invention, the power storage unit is a lithium-iron battery.

Thereby, no matter in the outdoor activity, disaster rescuing, mountain-hiking, camping, fishing, home-using, military training, or the like, the electric power can be obtained from the portable complex power supply apparatus disclosed in the present invention.

And, in the portable complex power supply apparatus of an embodiment of the present invention, not only the main part thereof, but also the addition parts thereof such as the wind power generator and the solar power generator are portable. Therefore, whole of the portable complex power supply apparatus can be carried by hand without the use of any vehicles.

Further, the portable complex power supply apparatus of the present invention is suitable for supplying electric power to electrical device with different electrical characteristics, because the output power thereof can be regulated to have a DC or AC power form and be adjusted to have a desired voltage and current value.

Moreover, the portable complex power supply apparatus generates the electric power from green energy such as wind energy or solar energy, and from manpower. Therefore, it is no pollution and conforms to the environmental protection concept. In addition, the generated power is monitored anytime for ensuring safety use and to maintain its steady and regular supply.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view of a portable complex power supply apparatus according to an embodiment of the present invention;

FIG. 2 is another perspective view of the portable complex power supply apparatus according to the embodiment of the present invention;

FIG. 3 is a block diagram of the portable complex power supply apparatus according to the embodiment of the present invention;

FIG. 4 is a schematic diagram of a portable wind power generator and a portable solar power generator according to an embodiment of the present invention; and

FIG. 5 is a schematic diagram of a portable wind power generator and a portable solar power generator according to another embodiment of the present invention.

### DETAILED DESCRIPTION OF THE PREFERRED EMBODIMENTS

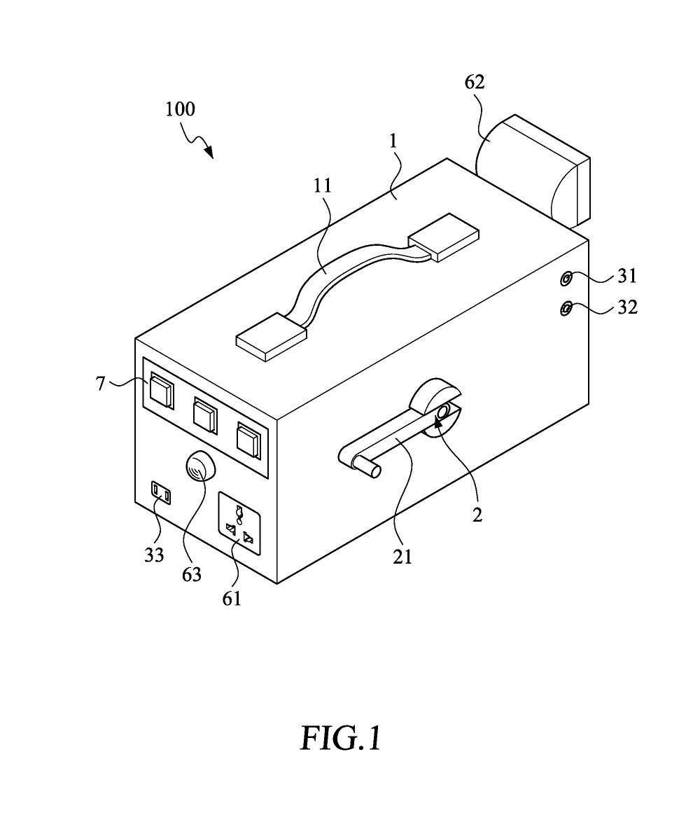

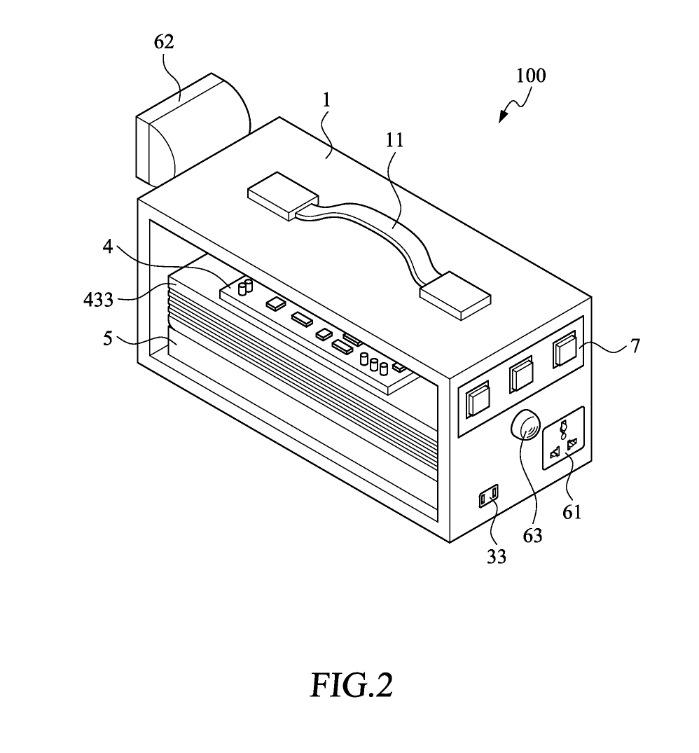

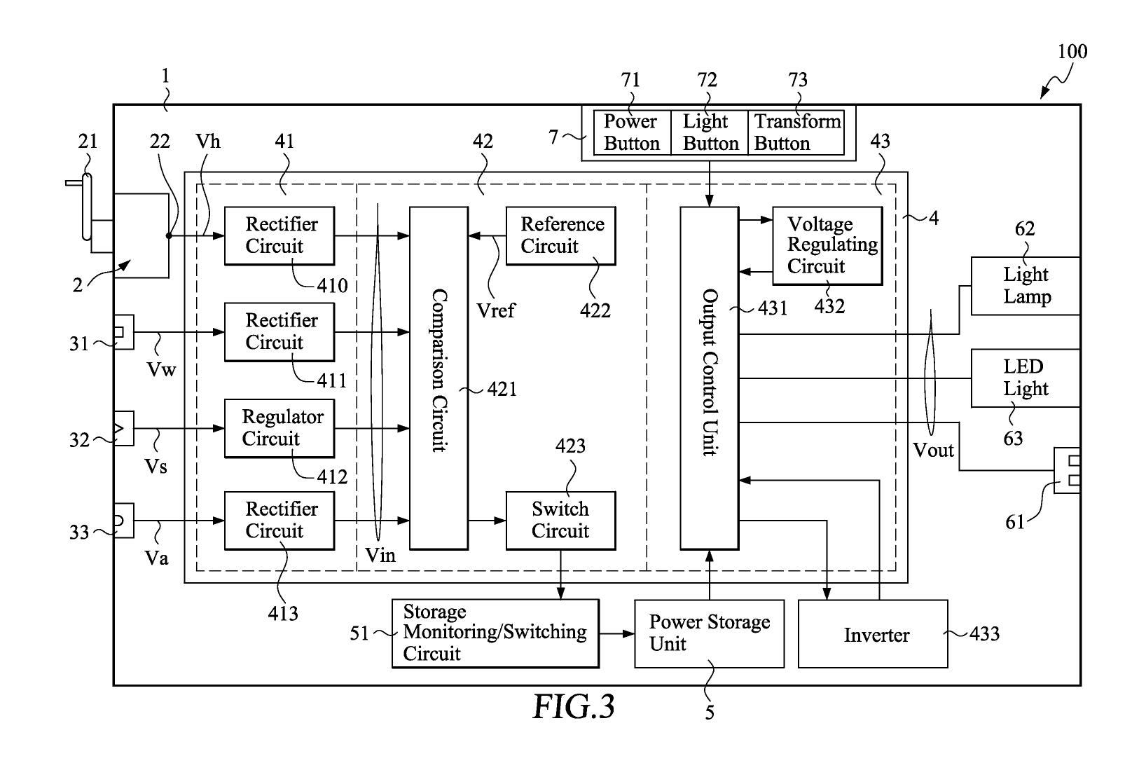

Please refer to FIGS. 1-3. FIG. 1 is a perspective view of a portable complex power supply apparatus according to an embodiment of the present invention; FIG. 2 is another perspective view of the portable complex power supply apparatus according to the embodiment of the present invention; and FIG. 3 is a block diagram of the portable complex power supply apparatus according to the embodiment of the present invention.

As shown in FIGS. 1-3, a portable complex power supply apparatus 100 according to an embodiment of the present invention mainly includes a portable case 1, a hand generator 2, a plurality of power input connection members, a power control circuit element 4, a power storage unit 5, and an output connector 61.

The portable case 1 in this embodiment is a box in which the members described above are disposed or contained. Preferably, the portable case 1 is provided with a handle part 11 for the purpose of convenient for carrying.

The hand generator 2 is provided with a shaking member 21 provided on an outer portion of the portable case 1 and has a hand power output terminal 22. The hand generator 2 in this embodiment is a generator that generates an electric power Vh by winding the shaking member 21, and the electric power Vh is output from the shaking member 21 to the power control circuit element 4.

The power input connection members in this embodiment include a wind power input connection member 31, a solar power input connection member 32, and a household power input connection member 33, which are respectively used for connecting with a wind power generator, a solar power generator, and a household power source, so as to transmit the electric power from the generators and the power source to the power control circuit element 4. However, the power input connection members are not limited to this, only one type of the power input connection member may be given, such as, a wind power input connection member. Also, the number of the wind power input connection member is not limited, one or more power input connection members may be given.

Through the hand generator 2 and the power input connection members, electric power can be obtained anywhere. For example, in a place having a household power source, the electric power can be obtained by connecting the household power input connection member 33 to the household power source. And, even in a place having no household power source, the electric power can be obtained by a generator through the wind power input connection member 31 or the solar power input connection member 32. Besides that, the electric power can be obtained from the hand generator 2 by manpower.

The electric power Vh generated from the hand generator 2, the electric power Vw input from the wind power input connection member 31, the electric power Vs input from the solar power input connection member 32, and the electric power Va input from the household power input connection member 33 are all transmitted to the power control circuit element 4.

The power control circuit element 4 includes an input regulating circuit 41, a monitoring/switching circuit 42, and an output control circuit 43. In this embodiment, those circuits are formed integrally on one circuit board to reduce the volume thereof for the purpose of being disposed within the portable case 1 and being carried by user in such a manner.

The input regulating circuit 41 is electrically connected with the hand power output terminal 22 of the hand generator 2, the wind power input connection member 31, the solar power input connection member 32, and the household power input connection member 33 for regulating the received electric power.

In detail, the input regulating circuit 41 may include a rectifier circuit 410, a rectifier circuit 411, a regulator circuit 412, and a rectifier circuit 413. The electric power Vh generated from the hand generator 2 is rectified, by the rectifier circuit 410, from the AC power form to the DC power form; the electric power Vw input from the wind power input connection member 31 is rectified, by the rectifier circuit 411, from the AC power form to the DC power form; the DC electric power Vs input from the solar power input connection member 32 is regulated, by the regulator circuit 412, to be steady and stable; and the household power Va input from the household power input connection member 33 is rectified, by the rectifier circuit 413, from the AC power form to the DC power form. And then, above input power will be transmitted to the monitoring/switching circuit 42.

The monitoring/switching circuit 42, also called a watchdog circuit, is electrically connected with the input regulating circuit 41. The monitoring/switching circuit 42 monitors the voltage and/or the current value of the input power Vin (e.g., power Vh, Vw, Va, and Vs), so as to determine to conduct or isolate the input power Vin from the input regulating circuit 41.

In this embodiment, the monitoring/switching circuit 42 includes a comparison circuit 421, a reference circuit 422, and a switch circuit 423. In the comparison circuit 421, the input power Vin is compared with a reference value Vref given by the reference circuit 422. If the comparison result between the input power Vin and the reference value Vref is false (for example, the input power Vin is too high, too low, or the like), the input power Vin will be isolated by opening the switch circuit 423. On the contrary, if the comparison result between the input power Vin and the reference value Vref is true, the input power Vin will be conducted by keeping the switch circuit 423 being a closed circuit. The reference value Vref is set depending on the withstand voltage or the available electric capacity of the portable complex power supply apparatus 100, or the like. In such a manner, it will be powered off by the monitoring/switching circuit 42 when having enough stored power, so as to avoid the circuits thereof being overloaded or damaged.

Note that each power Vh, Vw, Ws, and Va can be transmit to the input regulating circuit 41 or the monitoring/switching circuit 42 synchronous or asynchronous. That is, the input power Vin at a time may contain one or more of the power Vh, Vw, Ws, and Va. And, the monitoring/switching circuit 42 can monitor the total input power Vin and/or the individual power Vh, Vw, Ws, and Va.

The power storage unit 5 is electrically connected between the monitoring/switching circuit 42 and the output control circuit 43 of the power control circuit element 4. In this embodiment, the power storage unit 5 is a lithium-iron battery, which has the characteristics of large electric capacity, high discharge rate, high charge speed, high cycle life, and high stability. The power storage unit 5 is used for storing the input power Vin from the monitoring/switching circuit 42 and discharging the electric power stored therein. Preferably, the power storage unit 5 has individual charging circuit and discharging circuit, so that power charge and power discharge can be performed synchronously or asynchronously.

In addition, the power storage unit 5 is further electrically connected with a storage monitoring/switching circuit 51. The storage monitoring/switching circuit 51, which functions as the monitoring/switching circuit 42, conducts or isolates the input power Vin from the monitoring/switching circuit 42 depending on the amount of the electric power stored in the power storage unit 5, so as to avoid exceeding the electric capacity of the power storage unit 5.

The power storage unit 5 can discharge the electric power to the output control circuit 43, and the output control circuit 43 regulates the input power Vin into an output power Vout having a DC or AC power form and adjusts the output power Vout to have a predetermined voltage and current value. In this embodiment, the output control circuit 43 includes an output control unit 431 and a voltage regulating circuit 432, and is electrically connected with an inverter 433. The voltage regulating circuit 432, which includes a voltage boosting circuit and a bucking circuit, is used for adjusting the voltage value of the output power Vout under the control of the output control unit 431. The inverter 433 is used for transforming the DC power into the AC power.

The output power Vout of the output control circuit 43 is transmitted to an electrical device (not shown) via an output connector 61 electrically connected with the output control circuit 43. The output connector 61, which may have a receptacle configuration, is used for connecting with an electrical device. Preferably, in order to be interchangeably connected with different type terminals of electrical devices, the output connector 61 may have a special configuration by forming integrally different type receptacle jacks, as shown in FIGS. 1 and 2.

The output control circuit 43 can synchronously or asynchronously transmit the electric power to a light lamp 62 which uses AC power, a LED light 63 which uses DC power, and the like beside the output connector 61. In this embodiment, the light lamp 62 and the LED light 63 are disposed on the portable case 1 for the purpose of convenient for carrying.

The portable complex power supply apparatus 100 further includes an external operating unit 7. The external operating unit 7 is provided on the portable case 1 and is electrically connected with the power control circuit element 4. Through the external operating unit 7, the power control circuit element 4 can be manually operated by user, so as to set the reference value Vref, determine the power form and the voltage and current value of the output power Vout, or turn on/off the circuits of the portable complex power supply apparatus 100.

In this embodiment, the external operating unit 7 having a power button 71, a light button 72, and a transform button 73. The portable complex power supply apparatus 100 can be turned on/off by triggering the power button 71; the light lamp 62 can be turned on/off by triggering the light button 72; and the output power Vout of the output connector 61 can be transformed into a DC power form or a AC power form by triggering the transform button 73. Of course the number and functions of the buttons of the external operating unit 7 can be changed as appropriately.

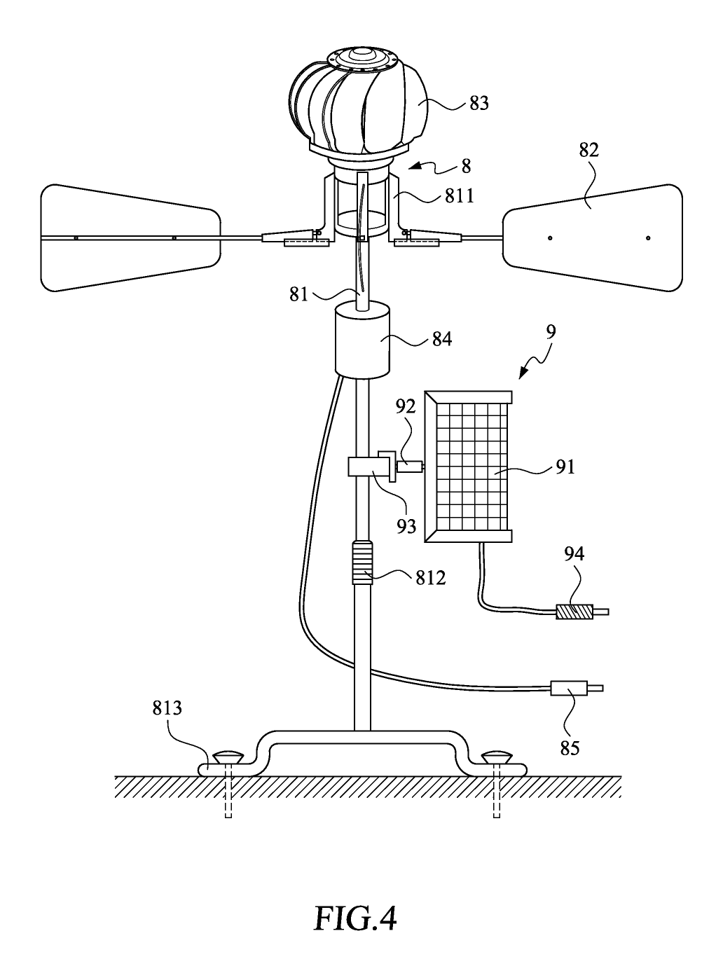

Referring to FIG. 4, which is a schematic diagram of a portable wind power generator and a portable solar power generator according to an embodiment of the present invention. The portable complex power supply apparatus 100 may further include a portable wind power generator 8 and a portable solar power generator 9.

The portable wind power generator 8 includes a foldable stand 81, a wind fan means 82, a wind turbine means 83, a generator unit 84, and a wind power output member 85.

In this embodiment, the foldable stand 81 includes: a frame body 811, which is foldable by a hinge thereon; a telescopic pole stand 812, whose length can be adjusted for changing the position of the wind fan means 82 and the wind turbine means 83; and a base 813, which may be provided with lock bores for locking to floor, is used for setting on the floor.

The wind fan means 82 and the wind turbine means 83, which are rotatable by wind, are both disposed on the foldable stand 81. When they rotate, the electric power is generated by the generator unit 84 and is output from the wind power output member 85 electrically connected with the generator unit 84. The wind power output member 85 in this embodiment is a connecting terminal as shown in FIG. 4, which is used for connecting to the wind power input connection member 31 to transmit the wind power Vw generated from the generator unit 84 to the power control circuit element 4.

The portable solar power generator 9 includes a solar panel 91, a joint member 92, a fixing member 93, and a solar power output member 94.

The solar panel 91 is used for generating the electric power by means of converting the energy light. The joint member 92 provided with an end thereof connected to the solar panel 91 and the other end thereof having one or more degrees of freedom related to the end that connected to the solar panel 91. By that, a light absorption angle of the solar panel 91 can be adjusted by moving the joint member 92. The fixing member 93 is connected to the other end of the joint member 92 for fixing on an object. The solar power output member 94, which is electrically connected with the solar panel 91, is used for connecting to the solar power input connection member 32 to transmit the solar power Vs generated from the solar panel 91 to the power control circuit element 4.

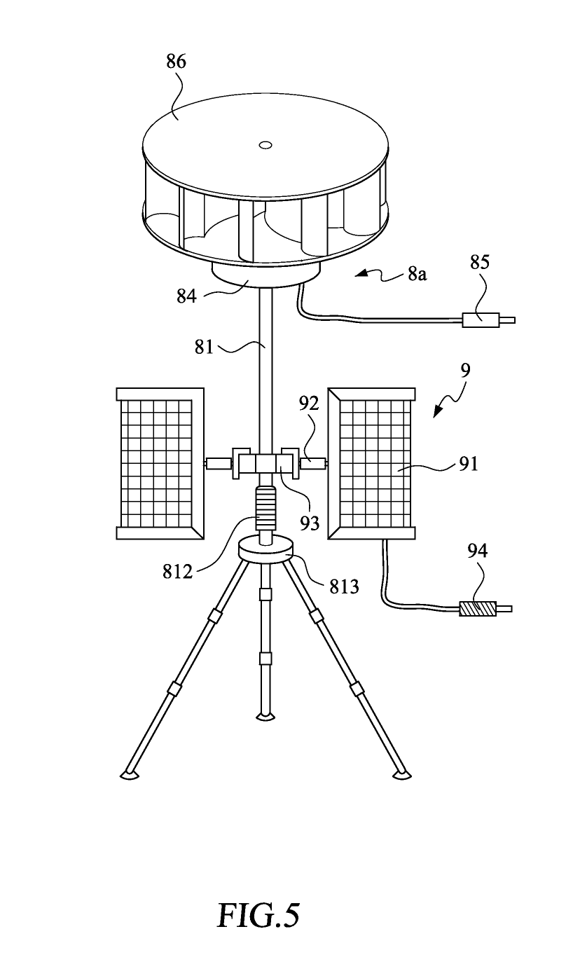

Referring to FIG. 5, which is a schematic diagram of a portable wind power generator and a portable solar power generator according to another embodiment of the present invention. A portable wind power generator 8a and the portable solar power generator 9 in this embodiment are similar to those in the embodiment of FIG. 4. The same elements in this embodiment are labeled with the same reference numbers as in the embodiment of FIG. 4. The difference therebetween is that the portable wind power generator 8a includes a wind wheel means 86 being rotatable by wind. The wind wheel means 86 is constructed by combining the wind fan means 82 with the wind turbine means 83, so as to get high generation as the wind fan means 82 and stable generation capability as the wind turbine means 83. The portable solar power generator 9 is the same as that in the embodiment of FIG. 4, the detail description thereof is omitted here as appropriate.

Because the portable wind power generator 8 and 8a and the portable solar power generator 9 have a minimized and fordable structure and the circuits for handling the electric power are disposed on the power control circuit element 4, the volume of the power generators are reduced in such a manner to prevent influence on carrying with the portable case 1. Therefore, the portable complex power supply apparatus 100 including the portable wind power generator 8 or 8a and the portable solar power generator 9 can be carried by manpower without the use of any vehicles.

As can be appreciated from the above embodiments, the spraying device of the present invention has industry worth which meets the requirement for a patent. The above description should be considered as only the discussion of the preferred embodiments of the present invention. However, a person having ordinary skill in the art may make various modifications to the present invention. Those modifications still fall within the spirit and scope defined by the appended claims.

What is claimed is:

1. A portable complex power supply apparatus comprising:
a portable case;
a hand generator provided with a shaking member provided on an outer portion of the portable case and having a hand power output terminal;
a wind power input connection member provided on the portable case for connecting with a wind power generator;
a power control circuit element including an input regulating circuit, a monitoring/switching circuit, and an output control circuit, the input regulating circuit being electrically connected with the hand power output terminal of the hand generator and the wind power input connection member to regulate the received electric power into an input power having a DC power form, the monitoring/switching circuit conducting or isolating the input power from the input regulating circuit to the output control circuit depending on the voltage and/or the current value of the input power, and the output control circuit regulating the input power into an output power having a DC or AC power form and adjusting the output power to have a predetermined voltage and current value;
a power storage unit electrically connected between the monitoring/switching circuit and the output control circuit for storing the input power or discharging the electric power stored therein; and
an output connector, electrically connected with the output control circuit, used for connecting with an electrical device to transmit the output power to the electrical device via the output connector.

2. The portable complex power supply apparatus as claimed in claim 1, further comprising an external operating unit, provided on the portable case, being electrically connected with the power control circuit element so as to operate the power control circuit element by the external operating unit.

3. The portable complex power supply apparatus as claimed in claim 1, further comprising a portable wind power generator including:
a foldable stand;
a wind fan means, disposed on the foldable stand, being rotatable by wind;
a wind turbine means, disposed on the foldable stand, being rotatable by wind;
a generator unit, disposed on the foldable stand, generating the electric power by means of rotation of the wind fan means and the wind turbine means; and
a wind power output member, electrically connected with the generator unit, being used for connecting to the wind power input connection member.

4. The portable complex power supply apparatus as claimed in claim 1, further comprising a solar power input connection member, provided on the portable case, being electrically connected with the input regulating circuit.

5. The portable complex power supply apparatus as claimed in claim 4, further comprising a portable solar power generator including:
a solar panel for generating the electric power by means of converting the energy light;
a joint member provided with an end thereof connected to the solar panel and the other end thereof having one or more degrees of freedom related to said end;
a fixing member connected to the other end of the joint member for fixing on an object; and
a solar power output member, electrically connected with the solar panel, being used for connecting to the solar power input connection member.

6. The portable complex power supply apparatus as claimed in claim 4, further comprising a household power input connection member, provided on the portable case and electrically connected with the input regulating circuit, being used for receiving a household power.

7. The portable complex power supply apparatus as claimed in claim 1, wherein the power storage unit is further connected with a storage monitoring/switching circuit which conducts or isolates the input power from the power control circuit element depending on the amount of the electric power stored in the power storage unit.

8. The portable complex power supply apparatus as claimed in claim 1, wherein the output control circuit of the power control circuit element is further electrically connected with an inverter.

9. The portable complex power supply apparatus as claimed in claim 1, wherein the output control circuit of the power control circuit element includes a voltage regulating circuit.

10. The portable complex power supply apparatus as claimed in claim 1, wherein the power storage unit is a lithium-iron battery.
